(19) United States
(12) Patent Application Publication
(10) Pub. No.: US 2005/0050447 A1
(43) Pub. Date: Mar. 3, 2005

(54) Accessibility of computer based training systems for the visually impaired

(76) Inventors: Kieran Guckian, Dublin (IE); Andrew Madigan, County Dublin (IE)

Correspondence Address: JACOBSON HOLMAN PLLC, 400 SEVENTH STREET N.W., SUITE 600, WASHINGTON, DC, 20004, US

(21) Appl. No.: 10/963,505

(22) Filed: Oct. 14, 2004

Related U.S. Application Data
(63) Continuation of application No. PCT/IE03/00057, filed on Apr. 17, 2003.

(51) Int. Cl. G06F 17/00

(52) U.S. Cl. 715/500.1

(57) ABSTRACT

A computer based training server (1) downloads a course player (10) an XML file (16) and a learning point action script (15) to a client. The client (2) only initially requires a browser at the start of the session. The action script (15) generates a visible HTML page (13) and a screen reader HTML page (14) derived from the content XML file (16). The screen reader page (14) is displayed with a zero frame size so that it is not visible, but is captured by a conventional screen reader for the visually impaired.

### FIELD OF THE INVENTION

The invention relates to accessibility of content to the visually impaired.

### PRIOR ART DISCUSSION

It is known to provide a “screen reader” which monitors output signals to a display screen and generates an audible output for the benefit of the visually impaired. One such product is that marketed by Freedom Scientific under the name “Jaws™”.

Where the output is plain text, screen readers can read the conventional HTML output generated for visible on-screen viewing. However, in practice, many outputs also contain images (possibly with animations) containing important information. This information is missed by screen readers at present, to the disadvantage of the visually impaired. Heretofore, the approach to addressing this problem has been to provide separate content solely for the screen reader. This increases the workload involved in generating content, and also introduces a significantly increased computer processing overhead.

U.S. Pat. No. 6,324,511 describes a system which both displays text and generates an audible output. U.S. Pat. No. 6,115,482 descries a system which generates audible and tactile outputs from hand gestures. U.S. Pat. No. 5,983,184 describes a system to allow a visually impaired user to control hypertext.

### SUMMARY OF THE INVENTION

According to the invention, there is provided a computer system comprising a processor, an input interface, a display device, and a speaker, wherein the processor is programmed to:
receive a content file,
process the content file to generate a frame for a visible output with images, and
process the content file to generate a frame for a screen reader output.

By generating frames for both visible and screen reader outputs, the system allows excellent versatility in output format from a content file.

In one embodiment, the processor generates the outputs with reference to settings including a setting indicating if the visible frame or the screen reader frame is to be maximised or minimised. Thus, the user can easily configure the output format, and can choose a content file accordingly.

In another embodiment, the processor processes the content file according to a player comprising a frameset, in turn comprising frames. A frameset provides a comprehensive structure for both the output frames (pages/windows) and for the associated executable code. This is particularly advantageous where the player is downloaded online from a server.

Preferably, the frames comprise the visible frame, the screen reader frame, and a navigation frame.

In one embodiment, the player comprises an action script for playing the content. This allows the content to be “played” in a controlled manner according to a unit defined by extent of the action script.

In one embodiment, the action script is held in a frame.

In another embodiment, the action script in held in the visible frame.

In another embodiment, the content file is loaded by the processor into the action script.

In a further embodiment, the settings are loaded into the action script.

In one embodiment, each frame has an associated executable file for generating the outputs in response to commands from the action script.

In another embodiment, the content file uses a mark-up language to store content.

In a further embodiment, the language is XML.

In one embodiment, the processor downloads the content file from a server.

In another embodiment, the processor downloads the content file and the player for outputting a unit of content.

In a further embodiment, the unit of content is a courseware learning point.

In one embodiment, the processor downloads a series of content files and associated players in succession to progress through content.

In another embodiment, the processor also downloads a settings file with each content file and player downloads a settings file with each content file and player download.

In a further embodiment, the outputs generated by the visible frame are used to generate screen reader outputs by transferring text from the visible frame to the screen reader frame.

The invention also provides a server comprising means for downloading a content file and a player to a client computer to allow the client computer to operate as a system as defined above.

The invention also provides a computer program product having software code for causing a digital computer to operate as a system as defined above.

In another aspect, the invention provides a method carried out by a server and a client for processing content, the method comprising the steps of:
the server loading content and an action script into a frameset comprising visible and screen reader frames;
the server downloading the frameset to the client; and
the client processing the action script to generate outputs for the visible frame and the screen reader frame.

In one embodiment, the content and the action script is held in the visible frame of the frameset.

### DETAILED DESCRIPTION OF THE INVENTION

### BRIEF DESCRIPTION OF THE DRAWINGS

The invention will be more clearly understood from the following description of some embodiments thereof, given by way of example only with reference to the accompanying drawings in which:

FIG. 1 is a high-level diagram illustrating interaction between a computer based training (CBT) server and a remote student's client;

FIG. 2 is a diagram illustrating architecture of the client while playing a course;

FIGS. 3 and 4 are flow diagrams showing a loading process;

FIG. 5 is a sample screen;

FIG. 6 is a flow diagram illustrating progress of a course;

FIG. 7 is a sample screen display;

FIGS. 8 and 9 are flow diagrams showing how a course progresses;

FIG. 10 is a sample display for a question; and

FIG. 11 is a flow diagram for outputting questions.

### Description of the Embodiments

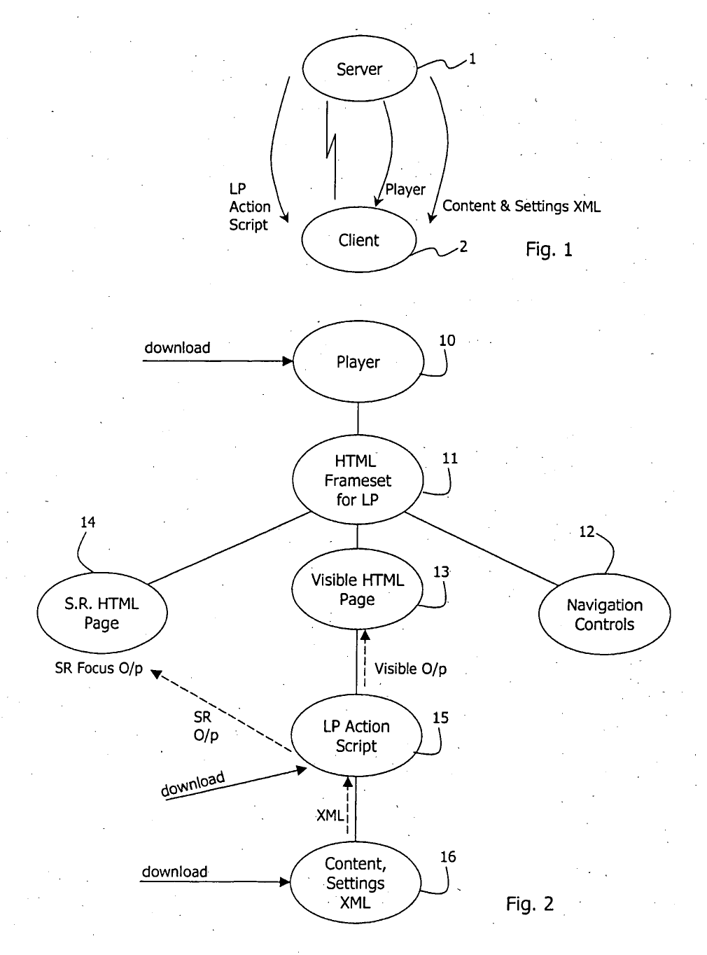

Referring to FIG. 1 a CBT (computer based training) server 1 on the Internet transmits signals to a remote client 2 executing a browser under student instructions. At a high level the server 1 downloads a course player, an XML file of content, and settings. There is one XML content file per learning point. The content file may contain images, possibly in the form of animations. A learning point (LP) action script movie is also downloaded for every LP. In general, there are multiple LPs in each learning object, and multiple learning objects in a full course. While the settings often remain the same for multiple learning points, they are downloaded with each content file.

Referring now to FIG. 2, operation of the client 2 is now described. The downloaded player 10 contains a HTML frameset 11 for each LP. The HTML frameset 11 in turn comprises:
navigation controls 12,
a HTML page 13 for visible displays, and
a screen reader HTML page 14.

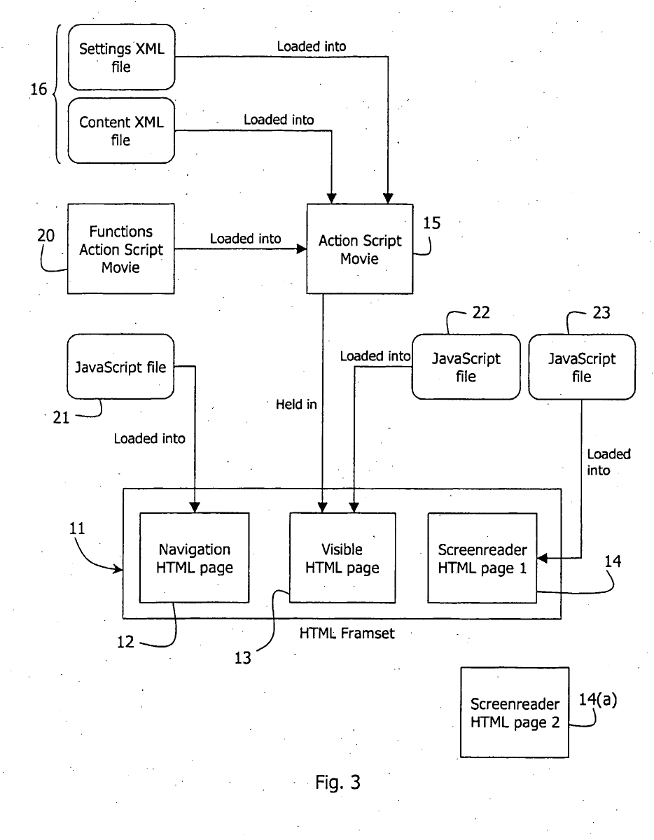

The loading process for the files in the client is illustrated in FIG. 3. The XML settings (preferences file) and XML content are in separate files 16, and these are loaded into an action script movie 15. Movie functions 20 are also loaded into the action script movie. The movie functions 20 come from the server and are downloaded for each Learning Point.

The player 10 also contains the frameset 11, which contains the navigation HTML page 12, the visible HTML page 13, and the screen reader HTML page 14. A JavaScript file 21 from the server for each Learning Point is loaded into the navigation HTML page 12, a JavaScript file 22 from the server for each Learning Point is loaded into the visible HTML page 13, and a JavaScript file 23 from the server for each Learning Point is loaded into the SR HTML page 14.

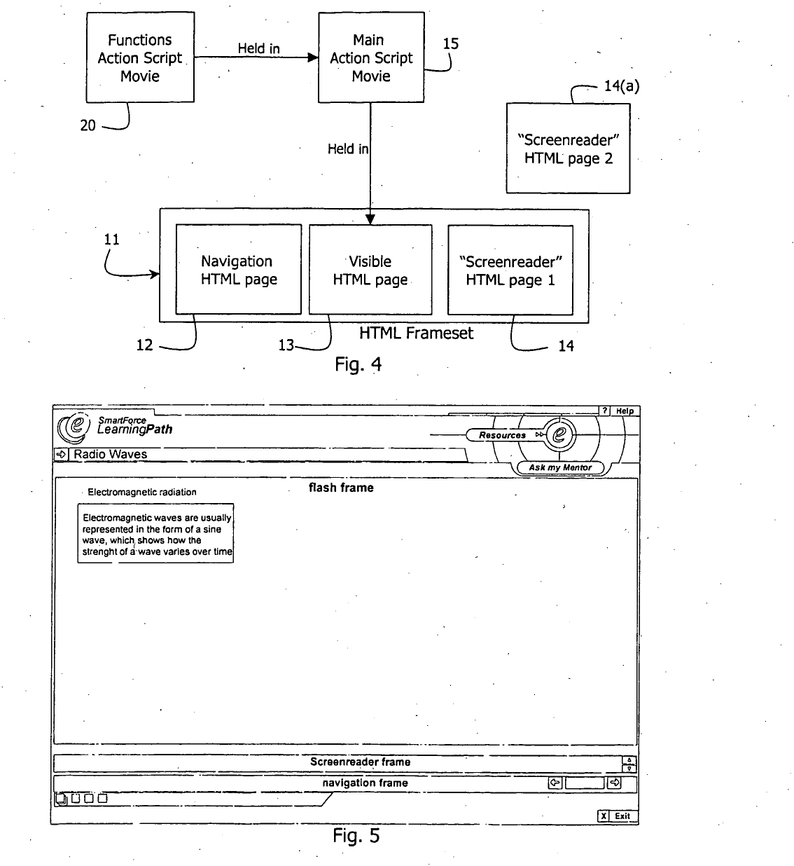

The client set-up after loading is shown in FIG. 4. The action script movie 15 holds the functions 20, and is in turn held in the visible HTML page 13.

The client 2 uses the navigation controls 12 to play a course that simultaneously populates both the SR HTML page 14 and the visible HTML page 13 using only one content source, namely the XML files 16. The content is defined by the XML document 16, and the screen shot of FIG. 5 is an example. The sighted user sees the image of FIG. 5, and the screen reader reads the outputs to the screen reader frame at the bottom of the screen. The height of the screen reader frame is actually set to zero.

The LP action script 15 processes the content XML 16 by parsing the XML tags. The result is two streams. One, a visual presentation to the visible HTML file 13 and two, a stream of textual HTML containing information corresponding to both the visible text and images to the screen reader HTML file 14.

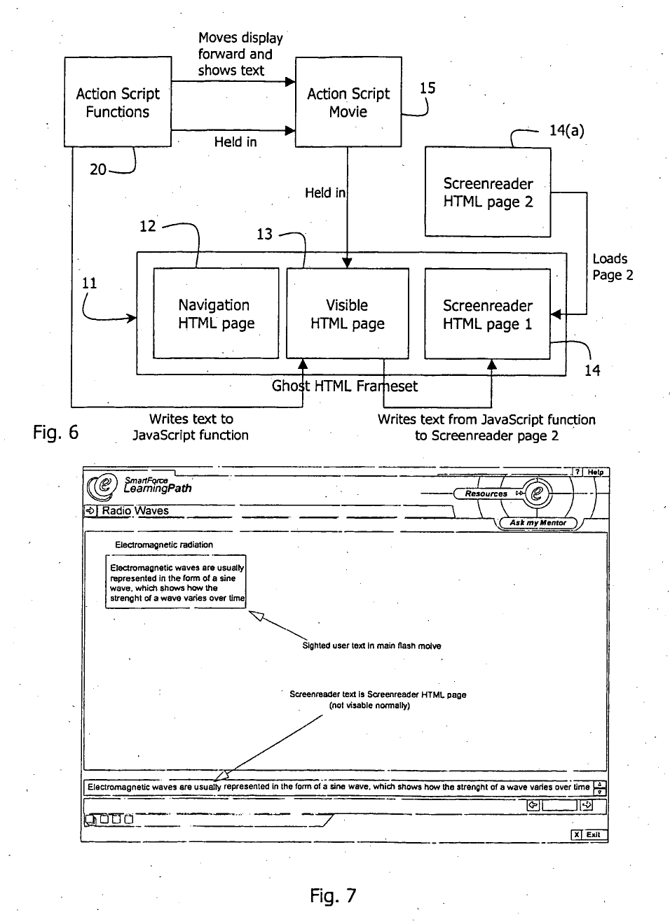

Referring to FIG. 6, when the XML files are loaded the action script functions call their “first row” function. This function goes to the first node of the XML file (that is held in the movie's memory) and displays the contents on screen. It also sets a screen reader variable to hold this content. Then this function calls a screen reader function that sends the contents of the screen reader variable out to a JavaScript function in the visible HTML page 13. This function loads in screen reader HTML page2 and writes the contents of the screen reader variable to that page. Finally, the screen's focus is set to the screen reader HTML frame of the frameset 11. This will make a screen reader read from that point. At this stage the sighted user sees the text content displayed on screen, and a screen reader user will be read out the contents of the screen reader HTML page 2.

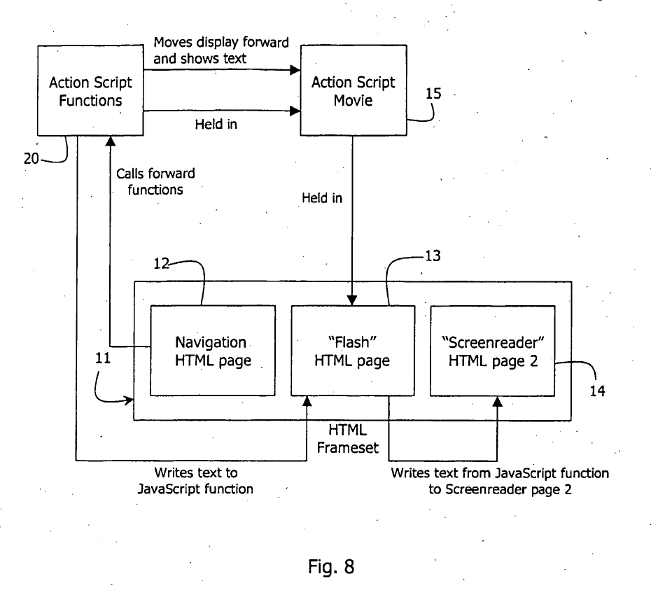

Referring to FIG. 7, the two sets of text are illustrated. However, as noted above the height of the screen reader frame is set to zero. From then onwards when the user clicks forward through standard content, and the process is as illustrated in FIG. 8. The main change is that the same Screen reader HTML page is written to. Also, the navigation page 12 calls the forward function.

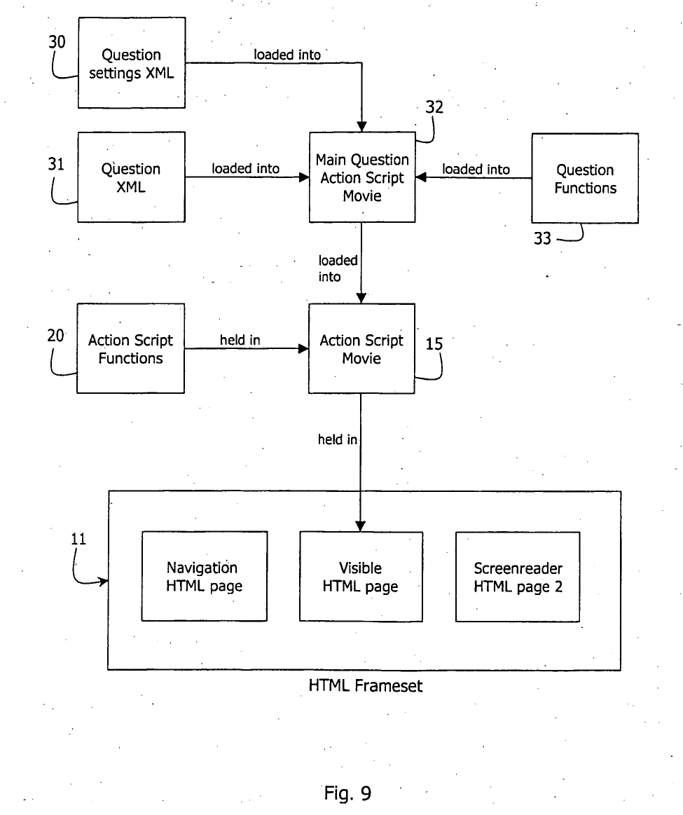

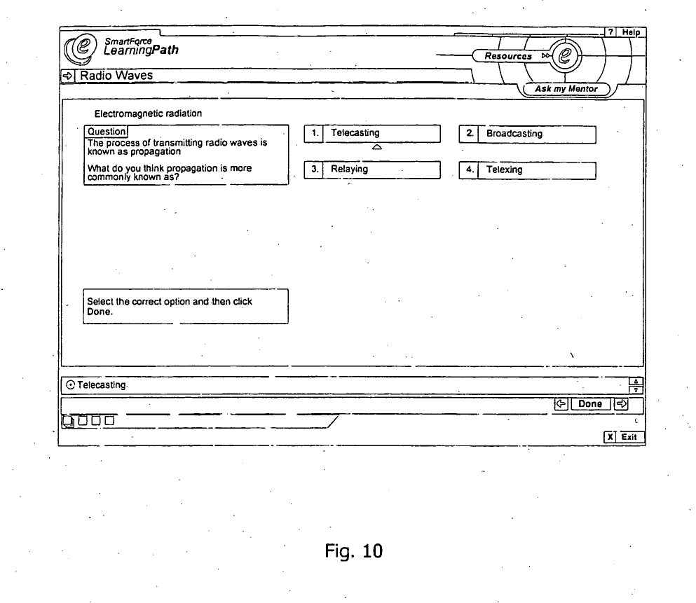

Referring to FIG. 9, when a user comes to a question a question movie 32 is loaded into the player 2. It follows a similar loading process to the base actionscript movie 15. The main question movie 32 is loaded into the base actionscriptmovie 15. The question movie 32 loads in a Question XML file, a question settings XML file, and a question functions actionscript movie 33. There is a question settings file 30 and a question content file 31, both loaded into a main question action script movie 32. Question functions 33 are also loaded into the question action script movie 32, and the latter feeds into the main action script movie. FIG. 10 shows an image of a question, and an expanded screen reader frame containing a form-based question.

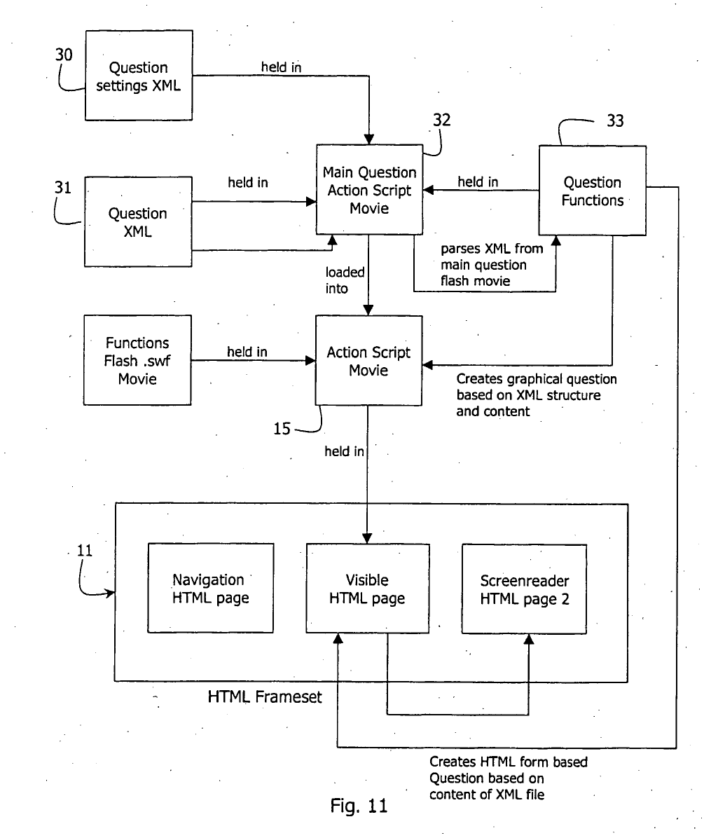

As shown in FIG. 11, when the question files are loaded, the question functions file 33 parses the XML loaded into the question action script movie 32 and makes the question base flash file display a graphical/multimedia version of the question. It also takes the same XML and rewrites it as a W3C compliant HTML form that is sent to the screen reader HTML page. If the question is a drag-and-drop question it also rearranges the order of the question so that it is presented in the screen reader HTML page as a series of forms, again via the visible HTML page.

When the user attempts the question and selects done (on screen) a function is called to judge the question. If the user is using a screen reader and attempts the form based question the results are sent into flash where they are passed to the same judging function, and the results are displayed on screen, and written to the screen reader HTML page.

Because the stream to the SR HTML file 14 is the “focus” output, it is this which is monitored by the SR. There is therefore a comprehensive audible output of information corresponding to all information outputted for the benefit of the student who is in a position to clearly see all displayed information.

It will be appreciated that the above has been achieved with only a single content stream. This achieves considerable savings over the prior approach. Also, there is very little additional client processor overhead.

The invention is not limited to the embodiments described but may be varied in construction and detail. For example, the programs may cause the screen reader page to be enlarged and the visible page to be minimised in certain situations. In this arrangement, the screen reader text may be enlarged. Choice of which frame to maximise is made by a user-configurable setting. Thus, the manner in which the frames (pages) are generated and processed allows excellent versatility. Also, the invention may be applied to download of content other than courseware. Also, the programs and content may be loaded from a storage medium into the computer for stand-alone use.

1. A computer system comprising a processor, an input interface, a display device, and a speaker, wherein the processor is programmed to:
receive a content file,
process the content file to generate a frame for a visible output with images, and
process the content file to generate a frame for a screen reader output.

2. A computer system as claimed in claim 1, wherein the processor generates the outputs with reference to settings including a setting indicating if the visible frame or the screen reader frame is to be maximised or minimised.

3. A computer system as claimed in claim 1, wherein the processor processes the content file according to a player comprising a frameset, in turn comprising frames.

4. A computer system as claimed in claim 3, wherein the frames comprise the visible frame, the screen reader frame, and a navigation frame.

5. A computer system as claimed in claim 4, wherein the player comprises an action script for playing the content.

6. A computer system as claimed in claim 5, wherein the action script is held in a frame.

7. A computer system as claimed in claim 6, wherein the action script in held in the visible frame.

8. A computer system as claimed in claim 5, wherein the content file is loaded by the processor into the action script.

9. A computer system as claimed in claim 2, wherein the settings are loaded into the action script.

10. A computer system as claimed in claim 1, wherein each frame has an associated executable file for generating the outputs in response to commands from the action script.

11. A computer system as claimed in claim 1, wherein the content file uses a mark-up language to store content.

12. A computer system as claimed in claim 11, wherein the language is XML.

13. A computer system as claimed in claim 1, wherein the processor downloads the content file from a server.

14. A computer system as claimed in claim 3, wherein the processor downloads the content file and the player for outputting a unit of content.

15. A computer system as claimed in claim 14, wherein the unit of content is a courseware learning point.

16. A computer system as claimed in claim 14, wherein the processor downloads a series of content files and associated players in succession to progress through content.

17. A computer system as claimed in claim 16, wherein the processor also downloads a settings file with each content file and player downloads a settings file with each content file and player download.

18. A computer system as claimed in claim 3, wherein the outputs generated by the visible frame are used to generate screen reader outputs by transferring text from the visible frame to the screen reader frame.

19. A computer program product comprising software code for causing a digital computer to operate as a system of claim 1 when the code executing on the digital computer.

20. A server comprising means for downloading a content file and a player to a client computer to allow the client computer to operate as a system of any of claim 14.

21. A method carried out by a server and a client for processing content, the method comprising the steps of:
the server loading content and an action script into a frameset comprising visible and screen reader frames;
the server downloading the frameset to the client; and
the client processing the action script to generate outputs for the visible frame and the screen reader frame.

22. A method as claimed in claim 21, wherein the content and the action script is held in the visible frame of the frameset.
